(19) United States
(12) Patent Application Publication
(10) Pub. No.: US 2013/0289744 A1
(43) Pub. Date: Oct. 31, 2013

(54) SMART SYSTEM FOR TRACKING PHYSICAL ACTIVITY IN CHILDREN, AND AWARDING CREDIT FOR, AND CONTROLLING USAGE OF, ELECTRONIC ENTERTAINMENT

(71) Applicant: ARTATECH, INC., Needham, MA (US)

(72) Inventors: Amir Ardavan Bavar, Franklin, MA (US); Ramin Abrishamian, Needham, MA (US)

(21) Appl. No.: 13/870,553

(22) Filed: Apr. 25, 2013

Related U.S. Application Data
(60) Provisional application No. 61/637,923, filed on Apr. 25, 2012.

(51) Int. Cl. G05B 11/01

(52) U.S. Cl. CPC G05B 11/01
USPC 700/9

(57) ABSTRACT

A system for tracking physical activity by a user and for controlling usage of an electronic device by the user, the system comprising:
a Digital Physical Activity Monitor (DPAM) configured to be worn by the user and record the physical activity performed by the user as physical activity time credits; and
a Digital Control Means (DCM) for controlling the amount of time that the user can use the electronic device, wherein the DCM receives physical activity time credits from the DPAM and enables the electronic device for a period of time corresponding to the physical activity time credits relayed by the DPAM.

### REFERENCE TO PENDING PRIOR PATENT APPLICATION

This patent application claims benefit of pending prior U.S. Provisional Patent Application Ser. No. 61/637,923, filed Apr. 25, 2012 by Amir Ardavan Bavar for SMART BRACELET FOR TRACKING PHYSICAL ACTIVITY IN CHILDREN AND GENERATING ELECTRONIC ENTERTAINMENT CREDIT (Attorney's Docket No. ABRISH-2 PROV).

### BACKGROUND OF THE INVENTION

Computers, televisions and video games have become an intrinsic part of daily life, particularly for children and young adults. According to a Kaiser Family Foundation study, persons aged 8 to 18 typically spend more than seven and a half hours a day (not counting during school-time) on computers, video game systems, televisions, smart phones, etc. According to a Wellesley College study, long hours on a computer can be detrimental to a child's health. Among other things, it can cause delays and strain on developing musculoskeletal systems. In addition, it takes away time that a child might otherwise spend in physical play, which helps children grow stronger physically. This lack of exercise may also lead to weight control issues. More particularly, a large number of children already suffer from obesity, and excessive use of computers and video games may only worsen the problem.

Mounting scientific evidence indicates that children need to be physically active every day. Engaging children in routine, age-appropriate physical activities has been shown to increase their overall long-term health and cognitive development. Parents who participate in teaching their children safe, fun and stimulating physical games and exercises also help their children develop good habits which can enhance their lifelong health and overall happiness.

Obesity is currently the leading health problem among today's school-aged children. Childhood obesity can lead to many early-onset health problems that include Type II diabetes, high blood pressure and other serious medical conditions. The ready availability of high calorie “junk food”, and the lack of regular physical activity, are major contributing factors to childhood obesity. Statistics show that approximately one in three children in the United States is overweight or obese. This is almost triple the number of children who were obese in 1963. One important way to help reduce obesity in children is to help children form good exercise habits.

The American Heart Association suggests that children ages 2 and over can benefit from at least one hour of moderate-intensity physical movement every day. For this reason, games and other activities that encourage physical activity should be encouraged over, or at least encouraged in addition to, sedentary activities such as television watching, working on computers and video game playing. Furthermore, studies also show that rewarding children for engaging in physical activity can motivate them to continue engaging in physical activity.

Taking this into consideration, the present invention is intended to provide parents, teachers and institutions with the means to control the amount of time that children spend using electronic devices (e.g., computers, video game systems, smart phones, etc.) while at the same time encouraging physical activity through rewards. For schools and institutions, the present invention can serve as a tool for promoting healthy competition amongst individual children, classes or grades, and/or schools, on a local, national and/or worldwide basis. Institutions can offer sponsorship programs for children supporting different charities and/or health drives. The present invention can, therefore, safely and directly address the aforementioned health issues on a daily basis.

### SUMMARY OF THE INVENTION

The present invention comprises the provision and use of a novel system for monitoring, tracking and limiting the day-to-day use of electronic devices such as computers, video game systems, televisions, smart phones and other devices (sometimes hereinafter referred to as a “target electronic device”), while at the same time promoting physical activity. The novel system links physical activity to the amount of time that the user (child) is allowed to use a target electronic device. The novel system promotes exercise and physical activity as an intrinsic part of the user's day, e.g., for every X minutes of physical activity, the user gets Y minutes of use of the target electronic device.

The novel system preferably comprises three components:

(i) a Digital Physical Activity Monitor (sometimes hereinafter referred to as a “DPAM”), preferably in the form of a smart bracelet, that is worn by the user and records the physical activity (intensity and/or time) performed by the user;

(ii) a Digital Control Means (sometimes hereinafter referred to as a “DCM”) which controls the amount of time that the user can use the target electronic device—the DCM can be hardware-based (sometimes hereinafter referred to as an “HW DCM”) such as a smart powerplug which controls the supply of power to a wallplug-powered target electronic device (e.g., a computer, a television, a video game system, etc.), or the DCM can be software-based (sometimes hereinafter referred to as an “SW DCM”) such as a smart phone app which is installed on a battery-powered target electronic device (e.g., a smart phone such as an iPhone, a portable music player such as an iPod, a tablet device such as an iPad, etc.) and controls use of the target electronic device; and

(iii) configuration software for configuring each DPAM and DCM (e.g., the users, the authorized target electronic devices, the rate at which physical activity earns use time on target electronic devices, etc.), as well as providing parental override controls.

Additionally, the system may also comprise an Internet server where user data can be automatically uploaded and stored—thereby allowing games and contests between individual children (users) or groups of children (e.g., classes or grades, and/or schools), on a local, national and/or worldwide basis.

In one form of the present invention, there is provided a system for tracking physical activity by a user and for controlling usage of an electronic device by the user, the system comprising:

a Digital Physical Activity Monitor (DPAM) configured to be worn by the user and record the physical activity performed by the user as physical activity time credits; and

a Digital Control Means (DCM) for controlling the amount of time that the user can use the electronic device, wherein the DCM receives physical activity time credits from the DPAM and enables the electronic device for a period of time corresponding to the physical activity time credits relayed by the DPAM.

In another form of the present invention, there is provided a method for tracking physical activity by a user and for controlling usage of an electronic device by the user, the method comprising:

providing a system comprising:
a Digital Physical Activity Monitor (DPAM) configured to be worn by the user and record the physical activity performed by the user as physical activity time credits; and
a Digital Control Means (DCM) for controlling the amount of time that the user can use the electronic device, wherein the DCM receives physical activity time credits from the DPAM and enables the electronic device for a period of time corresponding to the physical activity time credits relayed by the DPAM;

recording physical activity performed by the user as physical activity time credits; and

enabling the electronic device for a period of time corresponding to the physical activity time credits relayed by the DPAM.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic view showing one preferred form of the present invention;

FIG. 2 is a schematic view showing one preferred form of a hardware-based Digital Control Means (HW DCM); and

FIG. 3 is a schematic view showing a portion of the HW DCM shown in FIG. 2.

### DETAILED DESCRIPTION OF THE PREFERRED EMBODIMENTS

The present invention comprises the provision and use of a novel system for monitoring, tracking and limiting the day-to-day use of electronic devices such as computers, video game systems, televisions, smart phones and other devices (sometimes hereinafter referred to as a “target electronic device”), while at the same time promoting physical activity. The novel system links physical activity to the amount of time that the user is allowed to use a target electronic device. The novel system promotes exercise and physical activity as an intrinsic part of the user's day, e.g., for every X minutes of physical activity, the user gets Y minutes of use of the target electronic device.

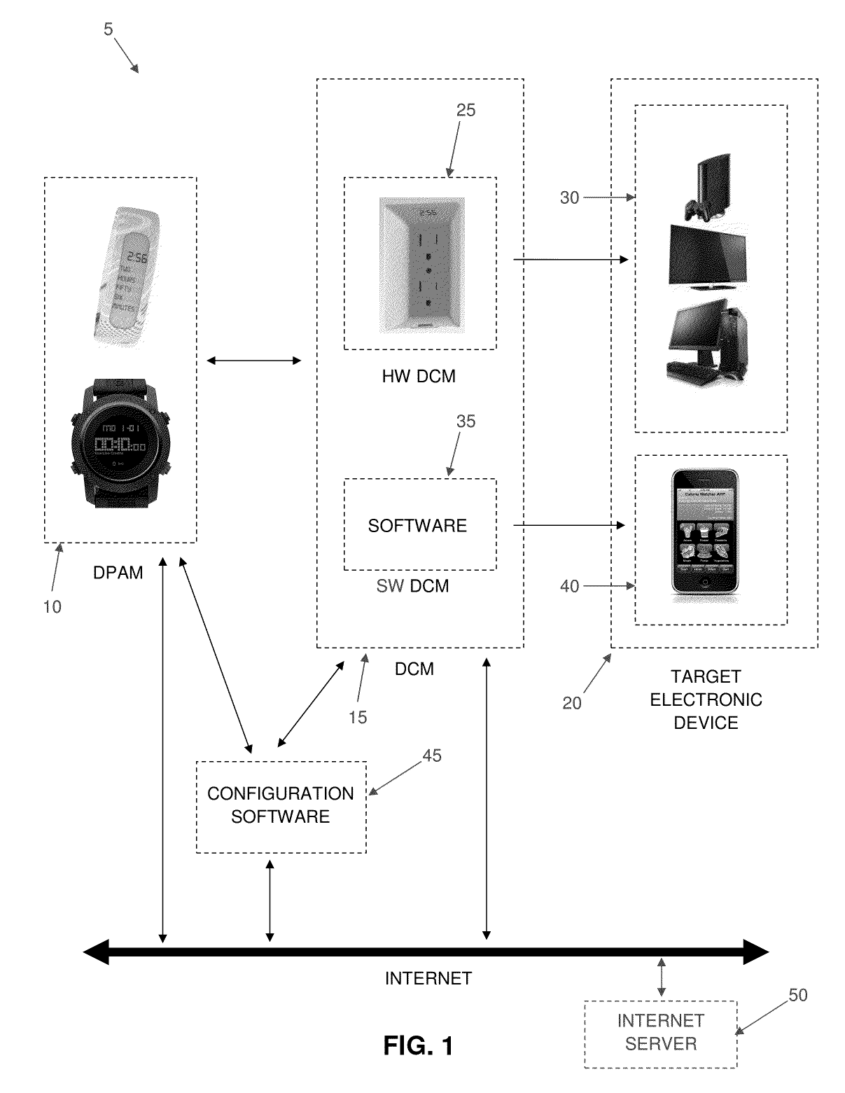

More particularly, and looking now at FIG. 1, there is shown a novel system 5 for monitoring, tracking and limiting the day-to-day use of electronic devices such as computers, video game systems, televisions, smart phones and other devices (sometimes hereafter referred to as a “target electronic device”), while at the same time promoting physical activity. Novel system 5 generally comprises (i) a Digital Physical Activity Monitor (sometimes hereinafter referred to as “DPAM”) 10, preferably in the form of a smart bracelet, that is worn by the user and records the physical activity (intensity and/or time) performed by the user; (ii) a Digital Control Means (sometimes hereinafter referred to as a “DCM”) 15 which controls the amount of time that the user can use a target electronic device 20—the DCM can be hardware-based (sometimes hereinafter referred to as an “HW DCM”) such as a smart powerplug 25 which controls the supply of power to wallplug-powered target electronic device 30 (e.g., a computer, a television, a video game system, etc.), or the DCM can be software-based (sometimes hereinafter referred to as an “SW DCM”) such as a smart phone app 35 which is installed on a battery-powered target electronic device 40 (e.g., a smart phone such as an iPhone, a portable music player such as an iPod, a tablet device such as an iPad, etc.) and controls use of the target electronic device; and (iii) configuration software 45 for configuring each DPAM 10 and DCM 15 (e.g., the users, the authorized target electronic devices, the rate at which physical activity earns use time on target electronic devices, etc.), as well as providing parental override controls.

Additionally, the system may also comprise an Internet server 50 where user data can be automatically uploaded and stored—thereby allowing games and contests between individual children (users) or groups of children (e.g., classes or grades, and/or schools), on a local, national and/or worldwide basis.

DPAM 10, preferably in the form of a smart bracelet, is worn by the user and records the physical activity (intensity and/or time) performed by the user. DPAM 10 preferably comprises a heart rate monitor so as to record the physical activity (intensity and/or time) performed by the user. Additionally and/or alternatively, DPAM 10 may comprise other means for detecting the physical activity (intensity and/or type) performed by the user, e.g., a motion sensor. This physical activity information is stored locally on DPAM 10 as “physical activity time credit” and can be viewed by the user on a digital display incorporated in the smart bracelet. When desired, the user can transfer any amount of accumulated physical activity time credit to any DCM 15 using a wireless electronic communication protocol (e.g., Bluetooth, WiFi, etc.) or using a hardwire electronic communication protocol (e.g., USB), whereby to enable use of a target electronic device 20 connected to that DCM 15. Furthermore, in the case where there are multiple target electronic devices in the household (e.g., a computer, a video game system, a television, a smart phone, a tablet device, etc.) controlled by DCMs 15, the user can control how much physical activity time credit is transferred to each such DCM 15. Additionally, as long as the user is using a particular target electronic device, the DPAM 10 will automatically transfer physical activity time credits to the appropriate DCM 15 as needed in order to keep that particular target electronic device enabled (assuming that the user has adequate physical activity time credits accumulated). The amount of physical activity time credits transferred to a DCM 15 is automatically deducted from the user's total available physical activity time credits on the user's DPAM 10. As a security measure, if the DPAM 10 is removed from the user's wrist without a parent's knowledge, the DPAM 10 is preferably configured so that all physical activity time credits on the DPAM 10 are zeroed and lost. This may be effected by providing an appropriate electrical sensor on the clasp of the smart bracelet, or by monitoring the heart rate monitor provided on the smart bracelet, or by monitoring a temperature sensor provided on the smart bracelet, etc.

In one preferred form of the invention, the DPAM 10 preferably comprises the following features:

(i) a digital display, preferably providing:
a central alphanumeric field displaying the current physical activity time credits available for use by the user, thus providing real-time feedback to the user regarding the total number of accumulated physical activity time credits currently available for use with target electronic devices connected to a DCM 15; preferably, the information in the central alphanumeric field of DPAM 10 is replaced by the name of the DCM 15 when communicating with, and transferring physical activity time credits to, a specific DCM 15; in one preferred form of the invention, the user can, with the use of a button on the DPAM 10, toggle between the different stored physical activity time credit information, e.g., between a “current” counter (which displays the current number of physical activity time credits available for use as play credits with target electronic devices 20), a history counter (which stores the total number of physical activity time credits earned since the manufacture of the DPAM 10 and which is not user-resettable), a trip counter (which stores the total number of physical activity time credits earned since the last time it was reset by the user), etc.;
a network status icon;
a battery status icon (preferably showing full charge, half charge, low charge, charging, etc.);
a field in the corner of the display providing real-time information on current heart rate, motion activity, etc.; and
a time/date feature, so that the user, by pushing a button on the DPAM 10, can choose to display the current time and date on the central alphanumeric field;

(ii) a flexible wrist band for securing the DPAM 10 to the wrist of the user so as to measure physical activity by the user—in one preferred form of the invention, different colored bands are provided for indicating an achievement ranking based on the total number of physical activity time credits accumulated by the user (e.g., in a manner similar to how a “black belt” is awarded in karate);

(iii) a waterproof case for allowing the DPAM 10 to be used in water sports;

(iv) a tamper-proof feature to prevent the DPAM 10 from being removed from the user's wrist without a parent's knowledge, preferably comprising a tamper-proof latch (clasp) so that the user cannot have another person wear their DPAM and thereby accumulate physical activity time credits on the user's DPAM—in one preferred form of the invention, the DPAM comprises a smart bracelet incorporating tamper-proof technology (e.g., a closed magnetic circuit or other method) that, if broken, will reset the physical activity time credits on the user's DPAM 10; in one preferred form of the invention, configuration software 45 can be used to instruct the DPAM to allow a user to remove the DPAM without losing physical activity time credits; and in one preferred form of the invention, the DPAM 10 can be programmed so that it can be taken off for charging, without losing physical activity time credits, as long as the period between taking the DPAM off and connecting it to the charger is less than a given time period, for example, less than 1 minute;

(v) a physical activity monitor, preferably in the form of a heartbeat monitor, a motion sensor, etc., so as to detect the physical activity of the user—in one preferred form of the invention, the physical activity monitor comprises a heartbeat monitor, and in one preferred form of the invention, the number of physical activity time credits earned per unit of time increases with the heart rate of the user; if desired, the heartbeat monitor can also be programmed to create an individualized pattern for a given user;

(vi) wireless electronic connectivity (e.g., Bluetooth, WiFi, etc.) to allow DPAM 10 to communicate with DCM 15, configuration software 45 and/or the Internet—among other things, such communication allows the configuration software 45 to configure DPAM 10, and allows the user to transfer physical activity time credits to DCMs 15 (either on-demand or automatically); and

(vii) USB connectivity to allow DPAM 10 to communicate with the configuration software 45 to configure DPAM 10, and for charging the battery of DPAM 10 (e.g., through a computer or other electronic device, or directly to a power source through a charger).

If desired, DPAM 10 can be used in conjunction with a hands-free magnetic charging station where the user places the smart bracelet (e.g., at night) for charging the battery.

As noted above, DPAM 10 detects and records the physical activity of the user (looking at both intensity and/or time) and accumulates physical activity time credits for the user which may then be used to enable a DCM 15 so as to allow a desired target electronic device 20 to be used. If desired, the rate at which physical activity time credits are accumulated can vary according to the level of physical activity engaged in by the user, e.g., one heartrate multiplier might be used for light exercise, a second heartrate multiplier might be used for moderate exercise, a third heartrate multiplier might be used for heavy exercise, etc.

In addition, DPAM 10 may also be programmed to account for bonus physical activity time credits, e.g., which may be awarded by a parent and/or teacher and be transmitted to DPAM 10 through configuration software 45.

Furthermore, DPAM 10 is preferably also configured to store user information, e.g., user name, user age, user grade, user team, etc.

If desired, DPAM 10 may also be provided with override privileges, such that the user does not need physical activity time credits to use a target electronic device.

### DCM 15

DCM 15 controls the amount of time that the user can use a target electronic device 20. DCM 15 can be hardware-based (sometimes hereinafter referred to as an “HW DCM”) such as a smart powerplug 25 which controls the supply of power to wallplug-powered target electronic device 30 (e.g., a computer, a television, a video game system, etc.), or DCM 15 can be software-based (sometimes hereinafter referred to as an “SW DCM”) such as a smart phone app 35 which is installed on a battery-powered target electronic device 40 (e.g., a smart phone such as an iPhone, a portable music player such as an iPod, a tablet device such as an iPad, etc.) and controls use of the target electronic device. In either case, DCM 15 enables the target electronic device 30 as long as the user has physical activity time credits and, once the user runs out of physical activity time credits, the DCM disables the target electronic device. Thus, DCM 15 comprises onboard memory for storing the quantity of physical activity time credits previously accumulated by the user, a “clock” or other timing means for determining the duration of device use, and means for automatically deducting physical activity time credits from the accumulated physical activity time credits of the user according to the device use time as tracked by the clock or other timing means of the DCM 15.

In the case of an HW DCM 25, the HW DCM 25 is preferably an electric socket that is plugged into a wallplug electrical power outlet, thus being interposed between the power cord of the target electronic device 30 and the wallplug electrical power outlet. The HW DCM 25 is preferably equipped with:

(i) a digital display which provides feedback to the user regarding the total number of physical activity time credits available to the user on that HW DCM 25 (the physical activity time credits which are being used belong to the user who is connected to HW DCM 25 with a DPAM 10), provides user information (e.g., which user is connected to the HW DCM 25), provides the name of the target electronic device 30 which is physically connected to the HW DCM 25, and provides connection status;

(ii) a device selection button which scrolls through a preset list of target electronic device names so that the user can select which target electronic device is connected to, and thus is being controlled by, the DPAM 10;

(iii) storage memory for storing DPAM information, device names and user data;

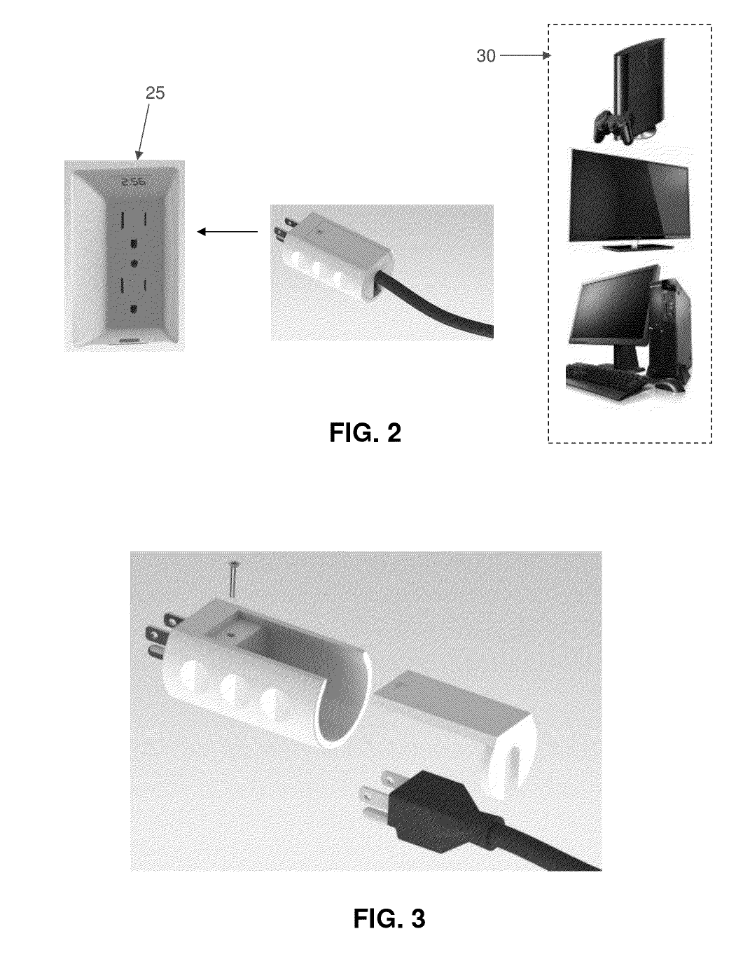

(iv) a mechanical lock that prevents removing the power cord of a target electronic device from the HW DCM 25 (see FIGS. 2 and 3);

(v) a control unit which allows the HW DCM 25 to be controlled and programmed using configuration software 45, e.g., for allowing target electronic devices to be used without enablement by a DPAM, or for allowing homeowners to reduce their electric bill (by reducing the amount of standby electric power usage) by scheduling the target electronic devices to turn off during the night, for allowing the HW DCM 25 to be turned on or off, for allowing the credit-to-time ratio (i.e., the rate at which the physical activity time credits translate into access time on a target electronic device) to be redefined, etc.;

(vi) wireless electronic communication connectivity (e.g., Bluetooth, WiFi, etc.) with a DPAM 10 (for transfer of physical activity time credits) or with configuration software 45 (for configuration of HW DCM 25);

(vii) an LED to indicate on/off status; and

(viii) an on/off switch which is programmable to shut-off or turn-on the power to the HW DCM 25 at certain programmable times.

In the case of an SW DCM 35, the SW DCM 35 is preferably software (e.g., an App) that is loaded on the battery-powered target electronic device 40 (e.g., a smart phone such as an iPhone, a portable music player such as an iPod, a tablet device such as an iPad, etc.). SW DCM 35 is programmed so as to limit use of the battery-powered target electronic device 40 depending on available physical activity time credits transferred to SW DCM 35. SW DCM 35 is also programmed for communicating with configuration software 45, whereby to enable parental control for purposes such as adding or removing physical activity time credits, scheduling usage time, defining the credit-to-time ratio (i.e., the rate at which the physical activity time credits translate into access time on a target electronic device), controlling access to controlled programs and/or Internet sites, etc.

### Configuration Software 45

Configuration software 45 is provided for configuring each DPAM 10 and DCM 15 (e.g., the users, the authorized target electronic devices, the rate at which physical activity earns use time on target electronic devices, etc.), as well as providing parental override controls.

By way of example but not limitation, such configurations may include:

(i) selecting a DCM 15;

(ii) adjusting the credit-to-time ratio (i.e., the rate at which the physical activity time credits translate into access time on a target electronic device;

(iii) bonus physical activity time credits for achieving predefined objectives and goals, e.g., such as through the use of special motivational games which give users bonus physical activity time credits for attaining goals such as reaching a specific number of exercise minutes per day, reaching a specific number of calories burned per day, achieving a combination of exercise minutes and calories, etc.

(iv) locking and unlocking a DCM 15;

(v) DCM scheduling;

(vi) enabling free use of a target electronic device;

(vii) adding or removing physical activity time credits to users;

(viii) providing a list of registered users;

(ix) modifying/deleting users; and

(x) configuring special games, such as taking care of a virtual pet or plant by participating in an exercise game, e.g., virtual pets or plants get food, water and sleep depending on the user's activities and physical activity time credits earned (the user uses his/her credits for virtual pet or plant care), and/or the credits can also be used for training virtual pets or plants to do special feats, e.g., the trained virtual pets can be entered in a school or worldwide competition in varied categories such as best virtual plant, best virtual pet trick, healthiest virtual pet or plant, etc.—the winners are awarded bonus physical activity time credits, and/or the competitors may be sponsored for donations to causes and charities (e.g., a monetary amount may be contributed for each physical activity time credit earned, in a manner similar to that of the “walk-a-mile” concept).

### Internet Server 50

The system 5 preferably also comprises an Internet server 50 where user data can be automatically uploaded and stored—thereby allowing games and contests between individual children (users) or groups of children (e.g., classes or grades, and/or schools), on a local, national and/or worldwide basis. By way of example but not limitation:

(i) families can create groups and register users to compete against each other for bonus physical activity time credits;

(ii) schools/teachers can create groups and register students to compete for bonus physical activity time credits;

(iii) users can compete in a world-wide competition on an event-by-event basis;

(iv) schools/teachers can create group goals and compete against other grades for bonus physical activity time credits that may be shared among the users, e.g., these goals can be extended to games with pets and plants, with groups competing for the most healthy pet or plant, and as the pet or plant grow and/or develop, etc., it will reflect successful achievements of the group's goals; and

(v) schools/teachers can create individual or group goals for sponsorship and donations to charities.

### Example

By way of example but not limitation, a parent might use configuration software 45 to configure the DPAM 10 of their child so that for every 1 minute of light exercise, the child accrues 1 minute of physical activity time credit, for every 1 minute of moderate exercise, the child accrues 2 minutes of physical activity time credit, and for every 1 minute of heavy exercise, the child accrues 3 minutes of physical activity time credit.

In addition, the configuration software 45 might be set (e.g., by default or by active configuration by the parent) to instruct each of the DCMs 15 to require 1 physical activity time credit for each 1 minute of use of a target electronic device by the child. Alternatively, the configuration software 45 might instruct the DCMs 15 to require a different number of physical activity time credits for each 1 minute of use of a target electronic device by the child, e.g., the configuration software 45 might instruct the DCMs 15 to require 2 physical activity time credits for each 1 minute of use of a target electronic device by the child. Furthermore, the configuration software 45 might be used to set different DCMs 15 to different settings, e.g., one DCM 15 might be set to “charge” 0.5 physical activity time credits for each 1 minute of use of a target electronic device by the child (such as for a target electronic device deemed “more desirable” by the parent, such as a computer) and another DCM 15 might be set to “charge” 2 physical activity time credits for each 1 minute of use of a target electronic device by the child (such as for a target electronic device deemed “less desirable” by the parent, such as a video game system). For the sake of the present example, it will be assumed that each DCM 15 is set to “charge” 1 physical activity time credit for each 1 minute of use of a target electronic device by the child.

The child thereafter (i) engages in light exercise for 10 minutes, causing the child's DPAM 10 to accrue 10 physical activity time credits (10×1=10), (ii) engages in moderate exercise for 20 minutes, causing the child's DPAM 10 to accrue 40 physical activity time credits (20×2=40), and (iii) engages in heavy exercise for 5 minutes, causing the child's DPAM 10 to accrue 15 physical activity time credits (5×3=15). Thus, the child has “earned” 65 physical activity time credits (10+40+15=65), and these accrued physical activity time credits are displayed to the child on the DPAM 10.

In addition, the parent might choose to use configuration software 45 to award the child with a “bonus” of an additional 30 physical activity time credits as a reward for the child eating a well-balanced meal. This would then bring the child's total of physical activity time credits to 95 physical activity time credits (65+30=95).

Thereafter, if the child wishes to use a target electronic device for some period of time, the child uses their DPAM 10 to transfer an appropriate number of physical activity time credits to the DCM 15 which controls use of that target electronic device. By way of example but not limitation, if the child wishes to use a hard-wired target electronic device 30 for 30 minutes, the child uses their DPAM 10 to transfer 30 physical activity time credits to the HW DCM 25 which controls the hard-wired target electronic device 30 which the child desires to use. This action reduces the child's total of available physical activity time credits to 65 (i.e., 95−30=65). This then enables the child to use the hard-wired target electronic device 30 for 30 minutes. As the child uses the hard-wired target electronic device 30, the HW DCM 25 controlling that hard-wired target electronic device 30 reduces the transferred physical activity time credits on that HW DCM 25 by 1 physical activity time credit for each 1 minute of use by the child. As the transferred physical activity time credits on the HW DCM 25 is reduced, the remaining number of transferred physical activity time credits is displayed to the child, preferably on both the child's DPAM 10 and on the HW DCM 25 associated with the hard-wired target electronic device 30 which is being used.

When the number of physical activity time credits on the HW DCM 25 is reduced to 0 (i.e., by the child's use of the target electronic device for 30 minutes), the HW DCM 25 prevents any further use of the hard-wired target electronic device 30.

If the child thereafter wishes to continue using the hard-wired target electronic device 30, and the child has additional physical activity time credits remaining on their DPAM 10 (in this example, the child would still have 65 remaining physical activity time credits, since 95−30=65), the child may use DPAM 10 to transfer additional physical activity time credits to the HW DCM 25 controlling the hard-wired target electronic device, whereby to enable further use of the hard-wired target electronic device. Alternatively, the child may use DPAM 10 to instruct the system to automatically deduct physical activity time credits from their “bank” of available physical activity time credits whenever the child has used up the physical activity time credits transferred to the HW DCM 25 and the child is in the middle of an active use session.

### Modifications

It will be appreciated that further embodiments of the present invention will be apparent to those skilled in the art in view of the present disclosure. It is to be understood that the present invention is by no means limited to the particular constructions herein disclosed and/or shown in the drawings, but also comprises any modifications or equivalents within the scope of the invention.

What is claimed is:

1. A system for tracking physical activity by a user and for controlling usage of an electronic device by the user, the system comprising:
a Digital Physical Activity Monitor (DPAM) configured to be worn by the user and record the physical activity performed by the user as physical activity time credits; and
a Digital Control Means (DCM) for controlling the amount of time that the user can use the electronic device, wherein the DCM receives physical activity time credits from the DPAM and enables the electronic device for a period of time corresponding to the physical activity time credits relayed by the DPAM.

2. A system according to claim 1 wherein the DCM is configured to aggregate physical activity time credits received from the DPAM and to reduce those physical activity time credits in accordance with the amount of time that the electronic device is used.

3. A system according to claim 2 wherein the DCM is configured to deactivate the electronic device in the absence of physical activity time credits.

4. A system according to claim 1 wherein physical activity time credits are transferred from the DPAM to the DCM on demand.

5. A system according to claim 1 wherein physical activity time credits are transferred from the DPAM to the DCM automatically when the physical activity time credits on the DCM are depleted.

6. A system according to claim 1 wherein the DPAM comprises a smart bracelet.

7. A system according to claim 1 wherein the DPAM records the physical activity performed by the user via a heartrate monitor.

8. A system according to claim 1 wherein the DPAM records the physical activity performed by the user via a motion sensor.

9. A system according to claim 1 wherein the physical activity time credits recorded by the DPAM are a function of the time duration of the physical activity performed by the user.

10. A system according to claim 1 wherein the physical activity time credits recorded by the DPAM are a function of the intensity of the physical activity performed by the user.

11. A system according to claim 1 wherein the electronic device comprises a wallplug-powered electronic device, and further wherein the DCM comprises a smart powerplug which controls the supply of power to the wallplug-powered electronic device.

12. A system according to claim 11 wherein the wallplug-powered electronic device comprises one from the group consisting of a computer, a television, and a video game system.

13. A system according to claim 1 wherein the electronic device comprises a battery-powered electronic device, and further wherein the DCM comprises a software app which is installed on the battery-powered electronic device and controls use of the battery-powered electronic device.

14. A system according to claim 13 wherein the battery-powered electronic device comprises one from the group consisting of a smart phone, a portable music player, and a tablet device.

15. A system according to claim 1 wherein the DPAM communicates with the DCM wirelessly.

16. A system according to claim 1 wherein the DPAM communicates with the DCM by wire.

17. A system according to claim 1 further comprising configuration means for configuring at least one of the DPAM and the DCM.

18. A system according to claim 17 wherein the configuration means is configured to add physical activity time credits to at least one of the DPAM and the DCM.

19. A system according to claim 17 wherein the configuration means is configured to configure the DCM to enable the electronic device regardless of physical activity time credits on the DCM.

20. A system according to claim 17 wherein the configuration means communicates with the DCM wirelessly.

21. A system according to claim 1 wherein the configuration means communicates with the DCM by wire.

22. A system according to claim 1 comprising a plurality of DCMs.

23. A system according to claim 17 wherein at least one of the DPAM, the DCM and the configuration means are connected to the Internet.

24. A method for tracking physical activity by a user and for controlling usage of an electronic device by the user, the method comprising:
providing a system comprising:
a Digital Physical Activity Monitor (DPAM) configured to be worn by the user and record the physical activity performed by the user as physical activity time credits; and
a Digital Control Means (DCM) for controlling the amount of time that the user can use the electronic device, wherein the DCM receives physical activity time credits from the DPAM and enables the electronic device for a period of time corresponding to the physical activity time credits relayed by the DPAM;
recording physical activity performed by the user as physical activity time credits; and
enabling the electronic device for a period of time corresponding to the physical activity time credits relayed by the DPAM.
